(19) United States
(12) Patent Application Publication
(10) Pub. No.: US 2024/0360706 A1
(43) Pub. Date: Oct. 31, 2024

(54) Method and System for Closing and Locking Flap

(71) Applicant: Illinois Tool Works Inc., Glenview, IL (US)

(72) Inventors: Yuan SUN, Shanghai (CN); Biao CHEN, Shanghai (CN); Mengzhe REN, Shanghai (CN); Yang LIU, Shanghai (CN)

(21) Appl. No.: 18/647,053

(22) Filed: Apr. 26, 2024

(30) Foreign Application Priority Data
Apr. 28, 2023 (CN) 202310485060.6
Apr. 22, 2024 (CN) 202410486900.5

(51) Int. Cl. E05B 83/34; E05B 81/06; E05B 81/70

(52) U.S. Cl. CPC E05B 83/34; E05B 81/06; E05B 81/70

(57) ABSTRACT

The present application provides a method for closing and locking a flap. The method comprises steps: (S1) driving a flap driving mechanism (132) to move by a predetermined stroke, the predetermined stroke enabling a locking end (192) of the flap (190) to reach a locking-end closed position; (S2) detecting that the locking end (192) of the flap (190) does not reach the locking-end closed position; and (S3) driving the flap driving mechanism (132) to move reversely, so as to drive the flap (190) to move back toward an open position.

### RELATED APPLICATIONS

The present application claims the benefit of Chinese Patent Application Nos. 202310485060.6, filed Apr. 28, 2023, and 202410486900.5, filed Apr. 22, 2024, each titled “Method and System for Closing and Locking Flap,” the contents of which are hereby incorporated by reference.

### TECHNICAL FIELD

The present application relates to a method and system for closing and locking a flap, in particular a flap for opening or closing a vehicle refueling or charging port.

### BACKGROUND

To enable vehicle refueling or recharging, a vehicle body is equipped with a refueling or charging port provided with a flap. When it is not necessary to refuel or recharge the vehicle, the flap of the refueling or charging port is closed and locked to remain in a closed position, thereby closing the refueling or charging port. When it is necessary to refuel or recharge the vehicle, the flap of the refueling or charging port is released from a locked state, and the flap of the refueling or charging port is moved from the closed position to an open position, so as to expose the refueling or charging port.

### SUMMARY OF THE DISCLOSURE

The present disclosure relates generally to a method and system for closing and locking a flap, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 shows a schematic block diagram of a flap system according to the present application.

FIG. 2A is a schematic diagram of an overall method for closing and locking a flap in the flap system of FIG. 1.

FIG. 2B is a flow chart of an exemplary aspect applying the method shown in FIG. 2A.

FIG. 3A shows an aspect of the flap system according to FIG. 1 and performing a process in FIG. 2B, in which the flap is in a closed position.

FIG. 3B shows the flap in FIG. 3A in an open position.

FIG. 3C shows a partial schematic diagram of a flap system using another position detector.

FIGS. 4A and 4B show a front perspective view and a rear perspective view of a locking device in FIGS. 3A and 3B, in which an elastic component for connecting the locking device to a base is shown.

FIG. 4C shows a perspective view, viewed from the bottom, of a base in FIGS. 3A and 3B.

FIG. 5A is a perspective view of an actuation device in FIGS. 3A and 3B.

FIG. 5B is a perspective view of the actuation device in FIG. 5A with a part of a housing removed.

FIG. 5C is an exploded view of the actuation device of FIG. 5A.

FIGS. 6A and 6B are respectively a front perspective view and a rear perspective view of a driving member and a driving rotation shaft in the actuation device of FIGS. 5A-5C.

FIGS. 7A and 7B are respectively a front perspective view and a front view of a driving gear in the actuation device of FIGS. 5A-5C.

FIG. 8 is a perspective view of a transmission rod assembly in the actuation device of FIGS. 5A-5C.

FIGS. 9A and 9B are respectively a front perspective view and a rear perspective view of a transmission gear in the actuation device of FIGS. 5A-5C.

FIG. 10A is a schematic diagram showing the state of a flap assembly when the flap is in the open position.

FIG. 10B is a schematic diagram showing the state of the flap assembly when the flap is in the closed position and the locking device is in a released position.

FIG. 10C is a schematic diagram showing the state of the flap assembly when the flap is in the closed position and the locking device is in a locked position.

FIG. 11 is a schematic block diagram of a controller in FIG. 1.

### DETAILED DESCRIPTION

Various specific embodiments of the present application will be described below with reference to the accompanying drawings which form a part of this specification. It should be understood that, where possible, the same or similar reference signs used in the present application refer to the same components. Although the terms indicating directions, such as “front”, “rear”, “upper”, “lower”, “left”, “right”, and “top”, are used in the present application to describe structural parts and elements in various examples of the present application, these terms are used herein only for ease of illustration and are determined based on the exemplary orientations shown in the corresponding accompanying drawings. Since the arrangements in the embodiments disclosed in the present application may be in different directions, these terms indicating directions are merely illustrative and should not be considered as limitations.

The present application provides a method and system for closing and locking a flap. The method and assembly of the present application make it possible to check whether the flap reaches a closed position before locking the flap, so as to ensure that the flap is locked in the closed position.

According to a first aspect of the present application, the present application provides A method for closing and locking a flap. The method comprises steps: (S1) driving a flap driving mechanism to move by a predetermined stroke, the predetermined stroke enabling a locking end of the flap to reach a locking-end closed position; (S2) detecting that the locking end of the flap does not reach the locking-end closed position; and (S3) driving the flap driving mechanism to move reversely, so as to drive the flap to move back toward an open position.

In the method of the first aspect, the flap is driven to move back to the open position in the step (S3).

In the method of the first aspect, the step (S2) is performed after the flap driving mechanism finishes the predetermined stroke.

In the method of the first aspect, the step (S3) is performed in response to detecting that the locking end does not reach the locking-end closed position.

In the method of the first aspect, a Hall sensor detects that the locking end of the flap does not reach the locking-end closed position in the step (S2).

In the method of the first aspect, a position switch detects that the locking end of the flap does not reach the locking-end closed position in the step (S2).

The method of the first aspect comprises performing step (S2-1) in the step (S2). The step (S2-1) turns the operation to the step (S3) in response to detecting that the locking end does not reach the locking-end closed position.

The method of the first aspect further comprises driving a locking device to lock the flap in a closed position. The step (S2) comprises performing step (S2-2), which turns the operation to the step (S4) in response to detecting that the locking end reaches the locking-end closed position.

The method of the first aspect further comprises (S0) receiving an instruction to close the flap, prior to the step (S1).

The method of the first aspect further comprises returning to the step (S0) following removing an abnormal circumstance, after the step (S3).

In the method of the first aspect, in the step (S1), a driving source is a single power source which is driven to rotate by a first stroke in a first direction, so as to drive the flap driving mechanism to move by the predetermined stroke. In the step (S3), the single power source is driven to rotate in a second direction opposite the first direction to drive the flap driving mechanism to move reversely, so as to drive the flap to move back toward the open position. In the step (S4), the single power source is driven to continue rotating in the first direction by a second stroke, so as to drive the locking device to lock the flap in the closed position.

In the method of the first aspect, the flap is used for a vehicle refueling or charging port.

According to a second aspect of the present application, the present application provides a flap system comprises a flap, a position detector and a controller. The flap comprises a locking end having a locking-end open position and a locking-end closed position. The flap is configured to be able to move from a flap open position to a flap closed position. The position detector is configured to detect a position of the locking end. The controller is configured to control the movement of the flap from the flap open position to the flap closed position. The controller controls the locking end to move toward the locking-end open position when the position detector detects that the locking end does not reach the locking-end closed position.

In the flap system of the second aspect, the position detector is a Hall sensor.

In the flap system of the second aspect, the position detector is a position switch.

The flap system of the second aspect further comprises a flap driving mechanism, a locking device and a locking driving mechanism. The flap driving mechanism is connected to the flap. The flap driving mechanism is configured to be movable by a predetermined stroke, so as to drive the flap to move from the flap open position to the flap closed position. The locking device is movable between a locked position in which the locking device locks the flap at the locking end and a released position in which the locking device releases the flap. The locking driving mechanism is configured to drive the locking device to move between the locked position and the released position. After the flap driving mechanism moves by the predetermined stroke, if a detection result of the position detector indicates that the locking end does not reach the locking-end closed position, the controller controls to drive the flap driving mechanism to move reversely, so as to drive the flap to move toward the open position. After the flap driving mechanism moves by the predetermined stroke, if a detection result of the position detector indicates that the locking end reaches the locking-end closed position, the controller controls to drive the locking driving mechanism to move the locking device to the locked position, so as to lock the flap in the closed position.

The flap system of the second aspect further comprises a single power source for driving the flap driving mechanism and the locking driving mechanism. The controller is configured to control the single power source to rotate by a first stroke in a first direction to drive the flap driving mechanism to move by the predetermined stroke, so as to close the flap. The controller is configured to control the single power source to rotate in a second direction opposite the first direction to drive the flap driving mechanism to move reversely, so as to open the flap. The controller is configured to control the single power source to continue rotating in the first direction by a second stroke to drive the locking driving mechanism, such that the locking device locks the flap in the closed position.

In the flap system of the second aspect, the flap system is used for a vehicle refueling or charging port.

In the third aspect of the present application, the present application provides a vehicle comprising a flap system according to the present application.

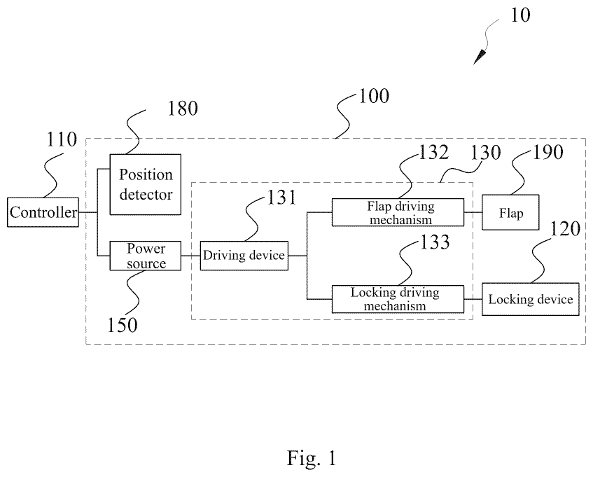

FIG. 1 shows a schematic block diagram of a flap system 10 according to the present application. As shown in FIG. 1, the flap system 10 comprises a flap assembly 100 and a controller 110. The controller 110 controls the operation of the flap assembly 100.

As further shown in FIG. 1, the flap assembly 100 comprises a power source 150, an actuation device 130, a flap 190, a locking device 120, and a position detector 180. In an aspect, the power source 150 is an electric motor. The actuation device 130 comprises a driving device 131, a flap driving mechanism 132, and a locking driving mechanism 133. The driving device 131 is connected to the power source 150 and is thus driven by the power source 150. The driving device 131 is also connected to the flap driving mechanism 132 and the locking driving mechanism 133 to drive the flap driving mechanism 132 and the locking driving mechanism 133 to move after being driven by the power source 150. The flap driving mechanism 132 is connected to a connecting end of the flap 190, and the locking driving mechanism 133 is connected to the locking device 120, such that a movement of the flap driving mechanism 132 drives the flap 190 at the connecting end of the flap 190 to drive the flap 190 to move between an open position and a closed position, and a movement of the locking driving mechanism 133 enables the locking device 120 to move between a locked position and a released position, so as to lock or release the flap 190. The position detector 180 is configured to detect, before the flap 190 is locked, whether a locking end of the flap 190 (the locking end being opposite the connecting end of the flap 190, and the locking device 120 locking the flap 190 at the locking end of the flap 190) reaches a locking-end closed position. The power source 150 is communicatively connected to the controller 110, such that the controller 110 can control the rotation of the power source 150. The position detector 180 is also communicatively connected to the controller 110, such that the position detector 180 can feed back a detection result to the controller 110, allowing the controller 110 to control the rotation of the power source 150 based on the detection result, so as to control the closing and locking of the flap 190. In some aspects, the position detector 180 can detect whether the locking end 192 of the flap 190 reaches the locking-end closed position based on a control signal from the controller 110.

Specifically, in the process of closing of the flap 190, the controller 110 controls the power source 150 to rotate (in a first direction) by a predetermined stroke. The rotation of the power source 150 drives the driving device 131 to rotate, and the rotation of the driving device 131 drives the flap driving mechanism 132 to rotate by a predetermined stroke, thus driving the flap 190 to move toward the closed position so as to drive the locking end 192 of the flap 190 to move toward the locking-end open position. In this process, the driving device 131 does not drive the locking driving mechanism 133 to move, such that the locking device 120 remains in the released position. After the controller 110 controls the power source 150 to rotate by the predetermined stroke, the controller 110 controls the power source 150 to pause the rotation. At this moment, in some aspects, the controller sends a control signal to the position detector 180 to instruct the position detector 180 to detect whether the locking end of the flap 190 reaches the locking-end closed position. In some other aspects, the position detector 180 sends, based on a position of the flap locking end relative to a base 101, to controller 110 a signal indicating whether the locking end of the flap 190 reaches the locked position. If the signal sent by the position detector 180 to the controller 110 indicates that the locking end of the flap 190 reaches the locking-end closed position, the controller 110 controls the power source 150 to continue rotating, and the continued rotation of the power source 150 continues driving the driving device 131 to continue rotating. In this course, the continued rotation of the driving device 131 drives the locking driving mechanism 133 to move, instead of driving the flap driving mechanism 132 to move, such that the locking device 120 moves to the locked position to lock the flap 190. If the signal sent by the position detector 180 to the controller 110 indicates that the locking end of the flap 190 does not reach the locking-end closed position, the controller 110 controls the power source 180 to rotate reversely (in a second direction opposite the first direction), thus driving the driving device 131 to rotate reversely. The reverse rotation of the driving device 131 drives the flap driving mechanism 132 to move reversely, thus driving the flap 190 to move back toward the open position so as to drive the locking end 192 of the flap 190 to move toward the locking-end open position. In an aspect, the flap 190 returns to the open position and the locking end 192 of the flap 190 returns to the locking-end open position. After an operator detects and removes an abnormal problem causing the locking end of the flap 190 to fail to reach the locking-end closed position, the controller 110 re-controls the rotation (in the first direction) of the power source 150 to close the flap 190, and after the locking end 192 of the flap 190 reaches the locking-end closed position, the power source 150 continues rotating such that the locking device 120 locks the flap 190. In some aspects, the position detector 180 is a Hall sensor. In some other aspects, a position switch is used as the position detector. Although only one power source 150 is used in the schematic block diagram shown in FIG. 1, in other aspects, two power sources are provided to respectively drive the flap driving mechanism 132 and the locking driving mechanism 133.

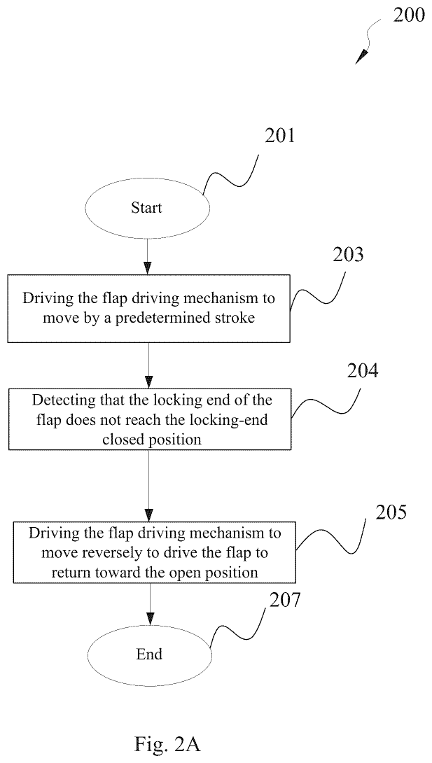

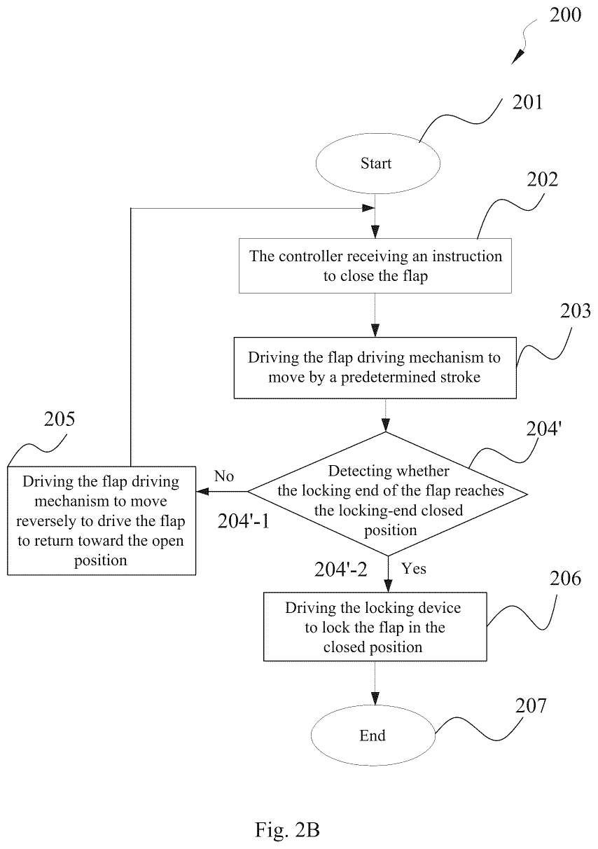

FIG. 2A is a schematic diagram of an overall method for closing and locking the flap 190 in the flap system 10 of FIG. 1.

The process starts at step 201.

In step 203, the flap driving mechanism 132 is driven to move by a predetermined stroke, which enables the locking end of the flap 190 to reach the locking-end closed position.

In step 204, it is detected that the locking end 192 of the flap 190 does not reach the locking-end closed position. In the aspects of the present application, this step is performed after the flap driving mechanism 132 moves by the predetermined stroke.

In step 205, the flap driving mechanism 132 is driven to move reversely, so as to drive the flap 190 to move back toward the open position. In the aspects of the present application, this step is performed in response to detecting that the locking end 192 of the flap 190 does not reach the locking-end closed position. In some aspects, the flap 190 is driven back to the open position. The process ends at step 207.

FIG. 2B is a flow chart 200 of an exemplary aspect applying the method shown in FIG. 2A.

The process starts at step 201.

In step 202, the controller 110 receives an instruction to close the flap 190. This instruction is, for example, sent by a user.

In step 203, the flap driving mechanism 132 is driven to move by a predetermined stroke to close the flap 190 so as to drive the locking end 192 of the flap 190 to move to the locking-end open position. In some aspects, the controller 110 controls the power source 150 to rotate by a first power source stroke in the first direction by sending an instruction to the power source 150, such that the flap driving mechanism 132 is driven to move by a predetermined stroke.

In step 204′, it is detected whether the locking end of the flap 190 reaches the locking-end closed position. In some aspects, after the flap driving mechanism 132 moves by the predetermined stroke, step 204′ is performed through the controller 110 sending a control signal to the position detector 180 to instruct the position detector 180 to measure a distance between the locking end of the flap 190 and the base 101. In some other aspects, after the flap driving mechanism 132 moves by the predetermined stroke, the position detector 180 sends, based on a position of the locking end of the flap 190 relative to the base 101, to the controller 110 a signal indicating whether the locking end of the flap 190 reaches the locking-end closed position. After the flap driving mechanism 132 is driven to move by the predetermined stroke, if the position detector 180 detects that the locking end of the flap 190 does not reach the locking-end closed position, a turning operation 204′-1 is performed to turn to step 205. If the position detector 180 detects that the locking end of the flap 190 reaches the locking-end closed position, a turning operation 204′-2 is performed to turn to step 206.

In step 205, the flap driving mechanism 132 is driven to move reversely, so as to drive the flap 190 to move back toward the open position. In some aspects, in response to detecting that the locking end 192 of the flap 190 does not reach the locking-end closed position, the controller 110 sends an instruction to the power source 150 to control the power source 150 to rotate in the second direction opposite the first direction, such that the flap driving mechanism 132 is driven to move reversely, driving the flap 190 to move back toward the open position so as to drive the locking end 192 of the flap 190 to move back toward the locking-end open position. In some aspects, the flap 190 is driven back to the open position, and the locking end 192 of the flap 190 returns to the locking-end open position. After step 205, the user removes an abnormal circumstance and then returns to step 202.

In step 206, the locking device 120 is driven to lock the flap 190 in the closed position. In some aspects, in response to detecting that the locking end 192 of the flap 190 reaches the locking-end closed position, the controller 110 sends an instruction to the power source 150 to control the power source 150 to continue rotating in the first direction by a second power source stroke, such that the locking device 120 is driven to reach the locked position, allowing the locking device 120 to lock the flap 190 in the closed position.

The process ends in step 207.

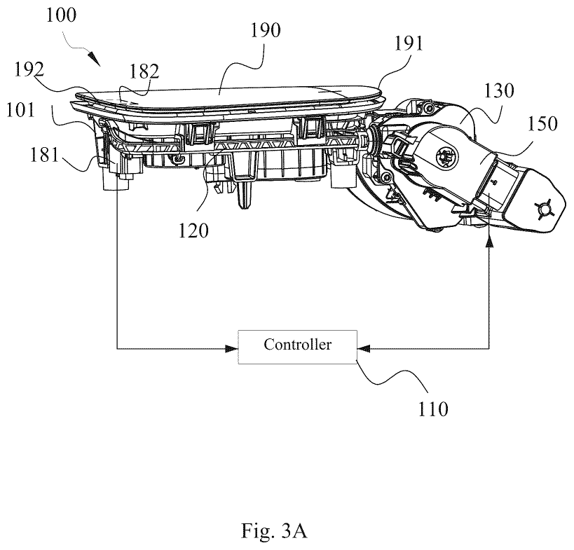

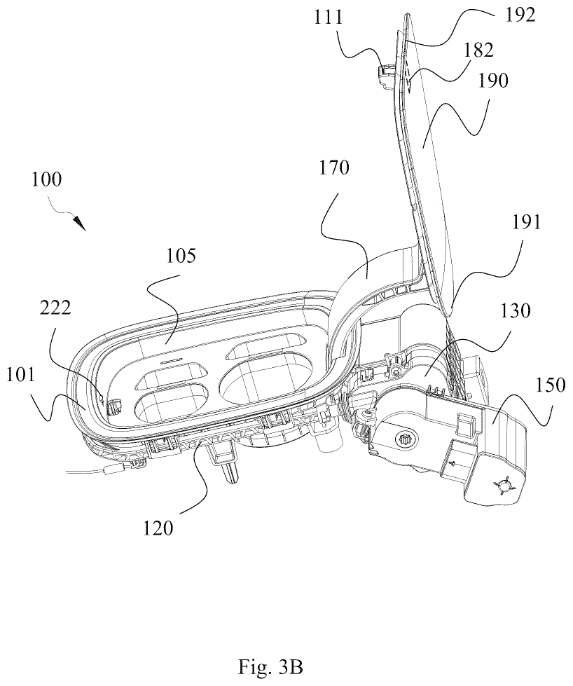

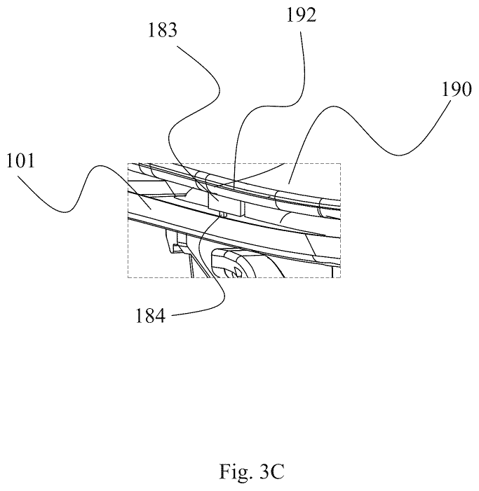

FIGS. 3A and 3B show an aspect of the flap system 10 according to FIG. 1 and performing the process in FIG. 2B. The flap system 10 comprises the flap assembly 100 and the controller 110. FIG. 3A shows the flap 190 of the flap assembly 100 in the closed position, and FIG. 3B shows the flap 190 of the flap assembly 100 in the open position. As shown in FIGS. 3A and 3B, the flap 190 comprises a connecting end 191 and a locking end 192 that are opposite each other. When the flap 190 is in the closed position, the connecting end 191 and the locking end 192 are respectively in a connecting-end closed position and the locking-end closed position. When the flap 190 is in the open position, the connecting end 191 and the locking end 192 are respectively in a connecting-end open position and a locking-end open position.

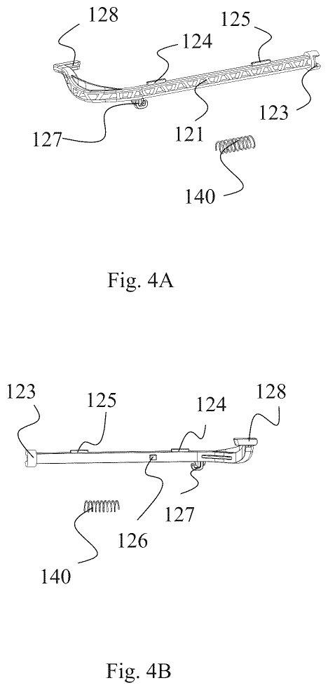

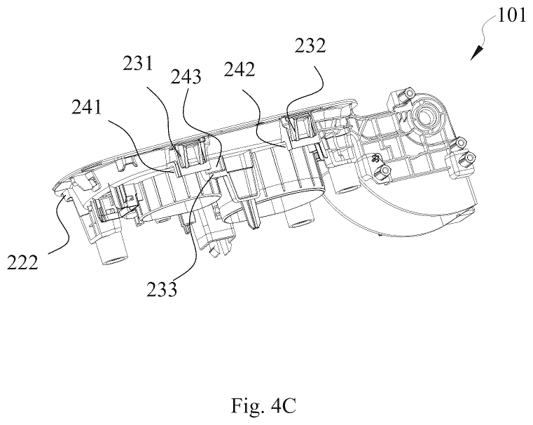

As shown in FIGS. 3A and 3B, the flap assembly 100 further comprises the base 101, the power source 150, the actuation device 130, and the locking device 120. The base 101 has an accommodating cavity 105 for accommodating an external component for refueling or charging. The base 101 is provided with a through hole 222 at a front end. A hinge 170 is connected to the flap 190 at the connecting end 191, and the hinge 170 is rotatably mounted to the base 101 by means of a hinge rotation shaft (not shown). The hinge rotation shaft and thus the connecting end 191 can be driven by the power source 150, such that the flap 190 can rotate relative to the base 101 to reach the closed position or the open position. Although in the aspect shown in FIGS. 3A and 3B, the flap 190 rotates relative to the base 101 by means of the hinge rotation shaft, it should be understood that in other aspects, the flap 190 is configured to move relative to the base 101 by means of other structures (e.g. four-bar linkage). A flap hole 111 is provided at the flap locking end 192. When the flap 190 is in the open position, the accommodating cavity 105 is exposed. When the flap 190 is in the closed position, the flap 190 covers the top of the accommodating cavity 105. The locking device 120 is mounted to the base 101. A locking pin 128 is provided at a front end of the locking device 120 (see FIGS. 4A and 4B). The locking device 120 has the locked position and the released position. When the locking device 120 is in the locked position and the flap 190 is in the closed position, the locking pin 128 of the locking device 120 is inserted into the through hole 222 of the base 101 and the flap hole 111 of the flap 190. When the locking device 120 is in the released position, the locking device 120 is withdrawn from the flap hole 111 of the flap 190, such that the flap 190 can rotate from the closed position to the open position. The power source 150 and the actuation device 130 are mounted to the base 101 and connected to each other, such that the rotation of the power source 150 can drive the actuation device 130. The flap 190 is connected to the actuation device 130, such that the flap 190 can be driven by the actuation device 130 to rotate to reach the open position or the closed position. A rear end of the locking device 120 is connected to the actuation device 130, such that the locking device can be driven by the actuation device 130 to move linearly to the left, thus reaching the released position. The locking device 120 can return to the locked position from the released position under the action of an elastic component 140 (shown in FIGS. 4A and 4B), so as to lock the flap 190. As shown in FIG. 3A, the controller 110 and the power source 150 are communicatively connected to control the rotation of the power source 150.

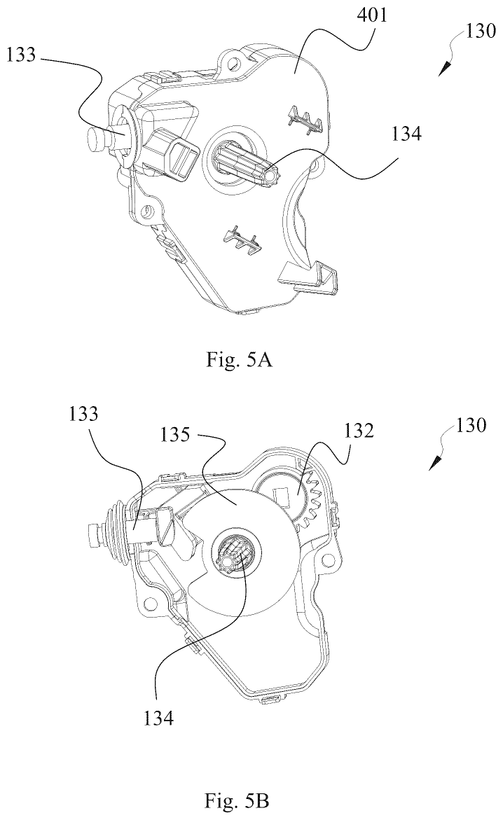

As shown in FIGS. 3A and 3B, the flap assembly 190 comprises one power source 150, the power source 150 cooperates with the locking device 120 shown in FIGS. 4A and 4B, the actuation device 130 shown in FIGS. 5A-9B and components therein, to drive the flap 190 to rotate between the open position and the closed position and to drive the locking device 120 to move between the locked position and the released position.

FIGS. 3A and 3B further show that a Hall sensor 181 is provided as the position detector at the front end of the base 101 of the flap assembly 100. The Hall sensor 181 is communicably connected to the controller 110 to enable the Hall sensor 181 to send a signal indicating a detection result to the controller 110. A magnet 182 is provided on an inner side of the front end of the flap 190. As the flap 190 moves from the open position toward the closed position, the magnet 182 gradually approaches the Hall sensor 181, such that the intensity of a magnetic field detected by the Hall sensor 181 gradually increases. When the locking end 192 of the flap 190 reaches the locking-end closed position, the intensity of the magnetic field detected by the Hall sensor 181 is equal to or greater than a set threshold. In this case, the Hall sensor 181 sends to the controller 110 a signal (a first signal of high level or low level) indicating that the flap locking end 192 reaches the locking-end closed position. On the contrary, if the locking end 192 of the flap 190 does not reach the locking-end closed position, the intensity of the magnetic field detected by the Hall sensor 181 does not reach a predetermined maximum threshold. In this case, the Hall sensor 181 sends to the controller 110 a signal (a second signal of low level or high level) indicating that the flap locking end 192 does not reach the locking-end closed position. The controller 110 controls the rotation of the power source 150 based on the detection result from the Hall sensor 181. Specifically, in the process of closing the flap 190, after the controller 110 controls the power source 150 to rotate by a predetermined first power source stroke, the controller 110 controls the power source 150 to pause the rotation. Then, if the Hall sensor 181 sends the first signal to the controller 110 indicating that the flap locking end 192 reaches the locking-end closed position, the controller 110 controls the power source 150 to continue rotating by a second power source stroke, such that the locking device 120 is driven to the locked position so as to lock the flap 190. If the Hall sensor 180 sends the second signal to the controller 110 indicating that the flap locking end 192 does not reach the locking-end closed position, the controller 110 then controls the power source 150 to rotate reversely, such that the flap 190 moves back toward the open position and the locking end 192 of the flap 190 moves back toward the locking-end open position. In an aspect, the flap 190 returns to the open position and the locking end 192 of the flap 190 returns to the locking-end open position. After an operator finds and removes an abnormal problem causing the flap locking end 192 to fail to reach the locking-end closed position, the controller 110 re-controls the rotation of the power source 150 to close the flap 190, and after the flap locking end 192 reaches the locking-end closed position, the power source 150 rotates to drive the locking device 120 to the locked position, so as to lock the flap 190. Although in FIG. 3A, the Hall sensor 180 is shown disposed at the front end of the base 101, the Hall sensor 180 is disposed at other positions in other aspects. Since the Hall sensor 181 provides a non-contact detection manner, using the Hall sensor 181 to detect whether the locking end 192 reaches the locking-end closed position enables the flap assembly according to the present application to have a simple structure and be easy to produce.

After the power source 150 rotates by the predetermined first power source stroke, the reasons why the flap locking end 192 does not reach the locking-end closed position include but are not limited to foreign matter stuck between the flap locking end 192 and the base 101, which causes the flap locking end 192 to tilt up. In the case of the flap 190 having an insufficient rigidity (for example, the flap 190 being made of a softer material, or the flap 190 being longer), after the power source 150 rotates by the predetermined first power source stroke, even if the locking end 192 of the flap 190 is tilted up due to foreign matter stuck between the flap locking end 192 and the front end of the base 101, etc., and thus does not reach the locking-end closed position, the connecting end 191 of the flap 190 can still reach the connecting-end closed position. In this connection, the flap 190 cannot completely close the accommodating cavity 105, and the locking pin 128 also fails to be aligned with the flap hole 111, causing the locking device 120 to fail to lock the flap 190 after reaching the locked position. In addition, in the aspect of the flap assembly 190 of the present application which will be further described below, when the connecting end 191 of the flap 190 reaches the connecting-end closed position while the flap locking end 192 is tilted up, it is neither possible to manually open the flap 190, nor to manually press down the flap locking end 192 to the locking-end closed position to close the accommodating cavity 105. In the present application, by providing the Hall sensor 181 to detect whether the flap locking end 192 reaches the locking-end closed position before moving the locking device 120 to the locking position, this situation can be found, and other damages caused thereby can be avoided.

In other aspects, other position detectors may be used to replace the Hall sensor 181. FIG. 3C shows a schematic diagram of such an aspect in which a position switch 183 (which may be a microswitch comprising a button 184) is used as the position detector. As shown in FIG. 3C, the position switch 183 is disposed on the inner side on the front end of the flap 190. It should be understood that the position switch 183 may be disposed on an upper surface of the base 101. In this aspect, when the locking end 192 of the flap 190 reaches the locking-end closed position, the button 184 of the position switch 183 comes into contact with the base 101, and the button 184 is thus triggered, such that the position switch 183 sends a first signal (of high level or low level) to the controller 110. If the locking end 192 of the flap 190 does not reach the locking-end closed position, the button 184 of the position switch 183 does not come into contact with the base 101, and the button 184 is not triggered, such that the position switch 183 sends a second signal (of low level or high level) to the controller 110. After the controller 110 controls the power source 150 to rotate by the predetermined first power source stroke, the controller 110 controls the power source 150 to pause the rotation. Then, if the controller 110 receives the first signal from the position switch 183 indicating that the locking end 192 reaches the locking-end closed position, the controller 180 controls the power source 150 to continue rotating by the second power source stroke, such that the locking device 120 is driven to the locked position so as to lock the flap 190. If the controller 110 receives the second signal from the position switch 183 indicating that the flap locking end 192 does not reach the locking-end closed position, the controller 110 controls the power source 150 to rotate reversely based on the second signal, such that the flap 190 moves back toward the open position and the locking end 192 of the flap 190 moves back toward the locking-end open position. In an aspect, the flap 190 returns to the open position and the locking end 192 of the flap 190 returns to the locking-end open position.

FIGS. 4A and 4B show a front perspective view and a rear perspective view of the locking device 120 in the flap assembly 100 of FIGS. 3A and 3B, in which the elastic component 140 for connecting the locking device 120 to the base 101 of the flap assembly 100 is shown. FIG. 4C shows a perspective view, viewed from the bottom, of the base 101 in the flap assembly 100 of FIGS. 3A and 3B, showing a mounting structure of the base 101 for fitting with the locking device 120.

As shown in FIGS. 4A and 4B, the locking device 120 comprises a lock bar 121, an engagement portion 123, a first guiding portion 124, a second guiding portion 125, a protruding portion 126, and a hook portion 127. The lock bar 121 has an elongated shape. As the direction shown in FIG. 4A, the lock bar 121 extends for a certain length from right to left, then for a certain length from front to back, and then for a certain length from left to right. The lock bar 121 has one end connected to the engagement portion 123, and the other end forming the locking pin 128. The locking pin 128 can extend into or withdraw from the through hole 222 of the base 101 and the flap hole 111 of the flap 190, so as to lock the flap 190 to the base 101 or to release the flap 190 from the base 101. The engagement portion 123 is configured for connection to a transmission rod assembly 133 (shown in FIGS. 5A to 5C), such that the locking device 120 and the transmission rod assembly 133 move together to the left and right. The first guiding portion 124 and the second guiding portion 125 are arranged on an upper side of the lock bar 121, and the first guiding portion 124 and the second guiding portion 125 are spaced apart by a certain distance. The protruding portion 126 is disposed on a rear side of the lock bar 121. The first guiding portion 124 and the second guiding portion 125 can cooperate with protruding portions 231 and 232 (shown in FIG. 4C) on the base 101 respectively, and the protruding portion 126 can cooperate with a receiving portion 233 on the base 101, such that the locking device 120 can be guided to move in a left-right direction. The hook portion 127 is arranged on a lower side of the lock bar 121, and the hook portion 127 is connected to a pull cord 122. The operator can pull the pull cord 122 to move the locking device 120 to the left (as the direction shown in FIG. 4A). In this way, the locking pin 128 is withdrawn from the through hole 222 of the base 101 and the flap hole 111 of a connection portion 112 of the flap 190, so as to release the flap 190 from the base 101. This operation is a manual unlocking initiated in a power-off state.

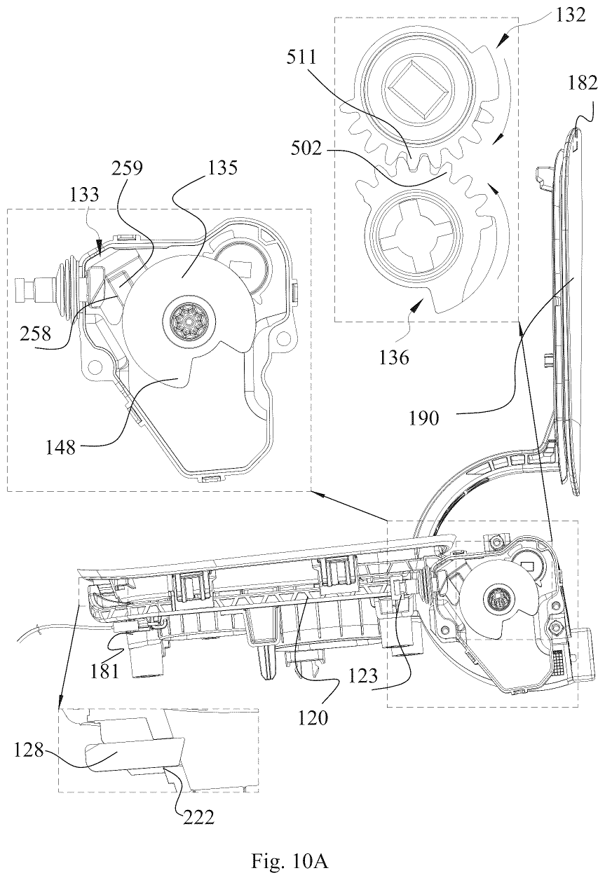

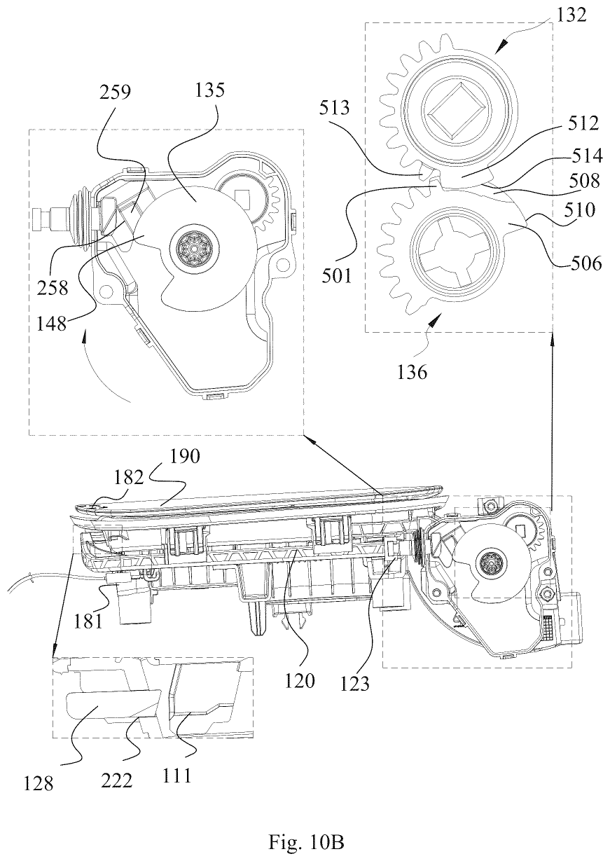

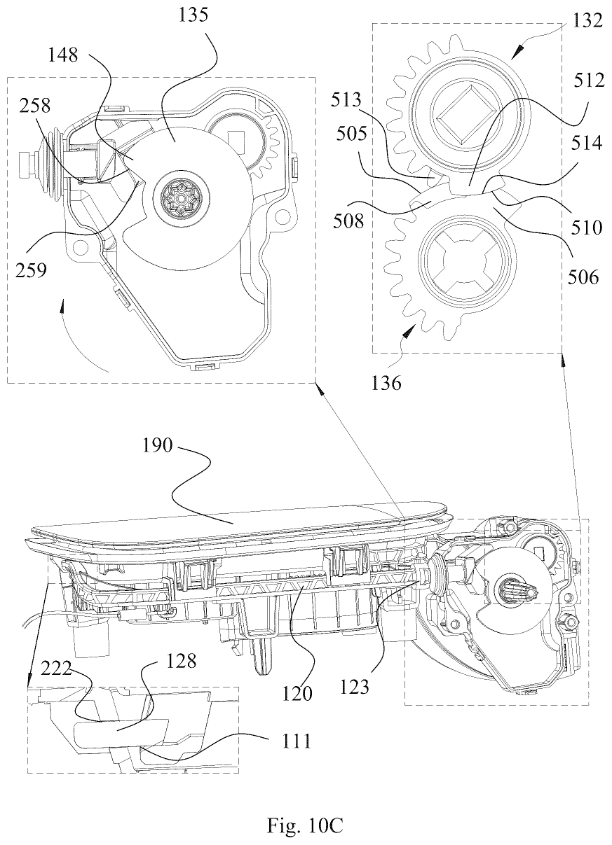

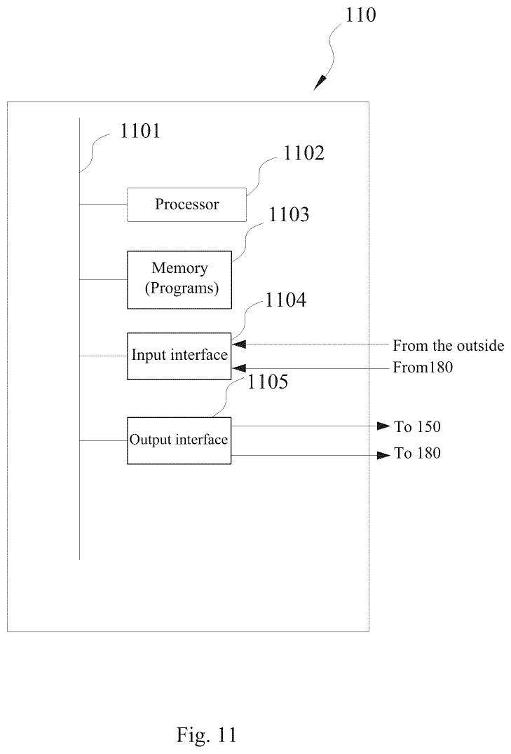

As shown in FIG. 4C, the protruding portions 231 and 232 are disposed on a front side of the base 101. The protruding portions 231 and 232 extend forward and downward from the front side of the base 101, such that recesses 241 and 242 are respectively formed between the protruding portions 231 and 232 and the front side of the base 101 for accommodating an upper portion of the locking device 120. The receiving portion 233 is also disposed on the front side of the base 101, and the receiving portion 233 extends downward from the bottom of the base 101 and extends toward the front side, such that a recess 243 is formed between the receiving portion 233 and the base 101 for accommodating the protruding portion 126 of the locking device 120. The protruding portions 231 and 232 and the receiving portion 233 are configured to guide and limit the movement of the locking device 120 in the left-right direction. The elastic component 140 is connected to the protruding portion 231 of the base 101 at one end, and is connected to the protruding portion 126 of the locking device 120 at the other end, such that the clastic component 140 provides a force to return the locking device 120 from the released position to the locked position, which will be described below with reference to FIGS. 10B and 10C.

FIGS. 5A-5C show the actuation device 130 in FIGS. 3A-3B. FIG. 5A is a perspective view of the actuation device 130. FIG. 5B is a perspective view of the actuation device 130 in FIG. 5A with a part of a housing removed, showing a structure in the housing of the actuation device 130. FIG. 5C is an exploded view of the actuation device 130 in FIG. 5A.

As shown in FIGS. 5A-5C, the actuation device 130 comprises the housing 401, the driving device 131, a transmission gear 132, the transmission rod assembly 133, and a seal 137. The driving device 131 serves as a driving input mechanism for receiving power input from the power source 150. The transmission rod assembly 133 serves as a locking driving mechanism for providing linear movement output. The transmission gear 132 serves as a flap driving mechanism for providing rotary movement output. The driving device 131, the transmission gear 132 and the transmission rod assembly 133 cooperate with each other to convert the power input into the linear movement output and the rotary movement output. Specifically, the driving device 131 comprises a driving shaft 134, a driving member 135, and a driving gear 136. The driving shaft 134 extends out of an opening on a front side of the housing of the actuation device 130 and extends into an opening of the power source 150 and is connected to the power source 150, such that the driving shaft can be driven to rotate by the power source 150. The transmission rod assembly 133 extends out of an opening on a left side of the housing 401 of the actuation device 130 and is engaged with the engagement portion 123 of the locking device 120, such that the locking device 120 and the transmission rod assembly 133 can linearly move together to the left and right to release and lock the flap 190. The driving member 135, the driving gear 136 and the transmission gear 132 are positioned in the housing 401. The driving member 135 is integrally and coaxially formed with the driving shaft 134, such that the driving member 135 can rotate as the driving shaft 134 rotates. The driving member 135 has a corresponding cooperation structure with the transmission rod assembly 133, such that a rotary movement of the driving member 135 can be converted into a linear movement of the transmission rod assembly 133. The driving gear 136 and the driving member 135 are fixed without a relative movement in the radial direction, and the rotation of the driving member 135 can drive the driving gear 136 to rotate. When rotating, the driving gear 136 can drive the transmission gear 132 to rotate around a transmission axis. The transmission gear 132 is connected to a flap rotating shaft (not shown), such that the rotation of the transmission gear 132 can drive the flap rotating shaft to rotate, so as to open or close the flap 190.

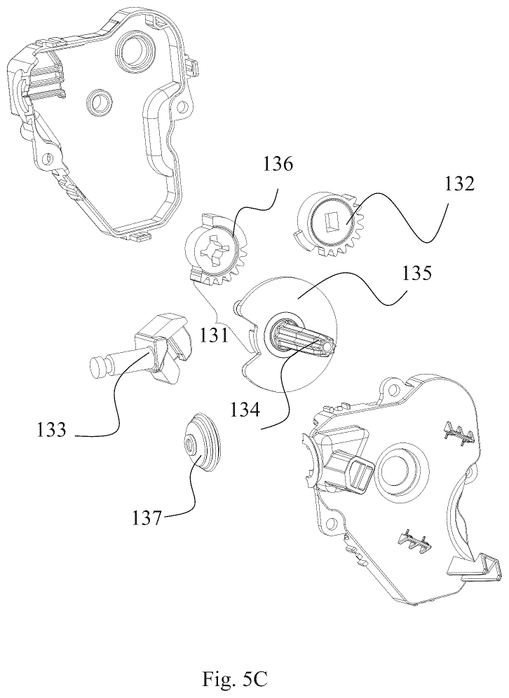

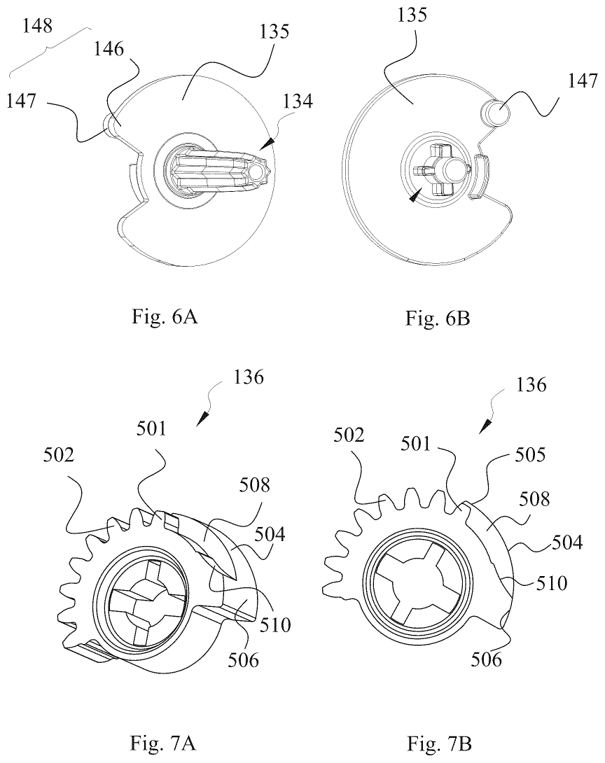

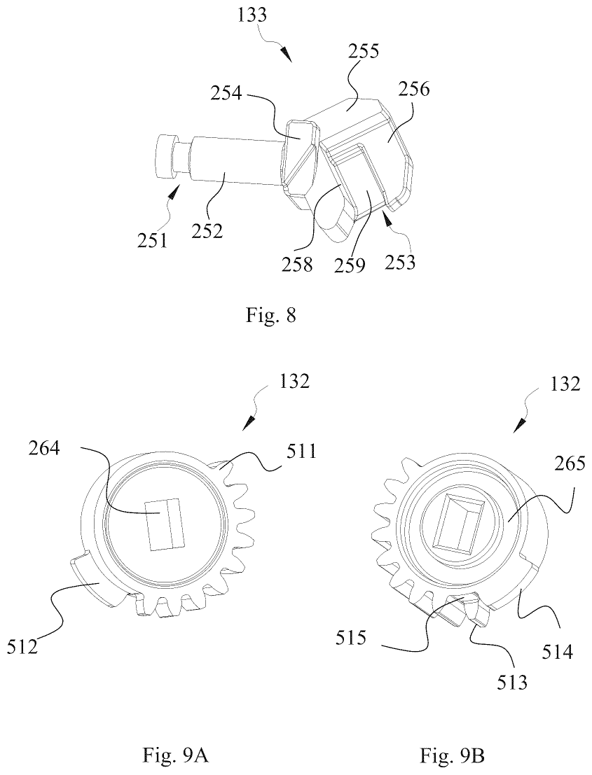

FIGS. 6A-9B further show various components in the actuation device 130. FIGS. 6A and 6B are respectively a front perspective view and a rear perspective view of the driving shaft 134 and the driving member 135. FIGS. 7A and 7B are respectively a rear perspective view and a front view of the driving gear 136; FIG. 8 is a front perspective view of the transmission rod assembly 133; and FIGS. 9A and 9B are respectively a front perspective view and a rear perspective view of the transmission gear 132.

As shown in FIGS. 6A and 6B, the driving member 135 is in the shape of a disk having a notch and is integrally formed with the driving shaft 134, such that the driving member 135 and the driving shaft 134 can rotate synchronously. The notch is formed by being radially recessed inward from an edge of a circumferential surface 134 of the driving member 135. Two corners are formed on the driving member 135 due to the notch. A protrusion 147 is provided on a rear side of one corner 146 of the two corners, and the protrusion 147 has a substantially cylindrical shape. The protrusion 147 can be accommodated in a guiding accommodating cavity 259 (shown in FIG. 8) of the transmission rod assembly 133 and move in the guiding accommodating cavity 259. The corner 146 and the protrusion 147 together serve as a driving portion 148 to drive the transmission rod assembly 133 to move as the driving member 135 rotates, so as to drive the locking device 120 to move.

As shown in FIGS. 7A and 7B, a first outer periphery portion and a second outer periphery portion are provided on an outer periphery of the driving gear 136. The first outer periphery portion is disposed on one side of the second outer periphery portion in a circumferential direction. The first outer periphery portion comprises a plurality of driving teeth 502. The plurality of driving teeth 502 are configured to be capable of engage with a plurality of transmission teeth 511 and an abutting tooth 513 of the transmission gear 132 (see FIGS. 9A and 9B). The second outer periphery portion comprises a driving gear abutting portion 504 and a driving gear limiting tooth 506. The driving gear 136 has a driving axis and can rotate about the driving axis. The driving gear abutting portion 504 is provided over a part of the axial extent, extends for a distance in the circumferential direction, and is connected to the adjacent driving tooth 502. The driving gear abutting portion 504 is disposed close to a rear side. In other words, the thickness (axial dimension) of the driving gear abutting portion 504 is less than the thickness of the plurality of driving teeth 502. The driving gear abutting portion 504 does not drive the transmission gear 132 to rotate. Specifically, the driving gear abutting portion 504 has a top portion 505. The top portion 505 is configured to be capable of cooperating with the abutting tooth 513 to block the rotation of the transmission gear 132. For clarity of description, the driving tooth of the plurality of driving teeth 502 closest to the second outer periphery portion is referred to as a first driving tooth 501. The top portion 505 of the driving gear abutting portion 504 is connected to the first driving tooth 501. The top portion 505 can be connected to a tooth top of the first driving tooth 501 so as to form an arc-shaped surface. A distance between the top portion 505 and the driving axis is equal to a distance between the plurality of driving teeth 502 and the driving axis.

The limiting tooth 506 of the driving gear 136 is arranged over a part of the axial extent and is axially offset from the driving gear abutting portion 504. The driving gear limiting tooth 506 is disposed close to a front side. The driving gear limiting tooth 506 is circumferentially spaced apart from the adjacent driving tooth 502 (i.e., the first driving tooth 501) by a distance to form an accommodating portion 508 for accommodating a transmission gear abutting portion 512 of the transmission gear 132 (see FIGS. 9A and 9B). The driving gear limiting tooth 506 has a driving gear limiting surface 510. The driving gear limiting surface 510 is located on a side portion of the driving gear limiting tooth 506 in the circumferential direction. The driving gear limiting surface 510 can cooperate with a transmission gear limiting surface 514 of the transmission gear 132 (see FIGS. 9A and 9B) to limit the magnitude of rotation of the driving gear 136 relative to the transmission gear 132.

As shown in FIG. 8, the transmission rod assembly 133 comprises a locking engagement portion 251, a rod portion 252, and a transmission engagement portion 253. The rod portion 252 has one end connected to the locking engagement portion 251, and the other end connected to the transmission engagement portion 253. The transmission engagement portion 253 cooperates with the driving member 135, such that the driving member 135 can drive the transmission rod assembly 133 to move. The transmission engagement portion 253 comprises a first boss 254, a second boss 255, and a third boss 256. These bosses are arranged in an overlapping manner in a front-to-back direction to form a stepped shape. The second boss 255 and the third boss 256 form an engagement surface 258 on the right side in the front-to-back direction, and the engagement surface 258 engages with the driving portion 148 of the driving member 135. The engagement surface 258 can be driven by the driving portion 148 to move to the left, so as to move the driving device 120 to the left to unlock the flap 190. The third boss 256 is recessed in the front-to-back direction to form the guiding accommodating cavity 259 for accommodating the protrusion 147 of the driving member 135. The locking engagement portion 252 is connected to the locking device 120. When the driving member 135 rotates, the protrusion 147 of the driving member 135 moves in or out of the guiding accommodating cavity 259, so as to move the transmission rod assembly 133 to the left and right, such that the locking device 120 can move to the left and right to release or lock the flap 190.

As shown in FIGS. 9A and 9B, the transmission gear 132 is substantially circular and has a transmission axis. The transmission gear 132 can rotate about the transmission axis. When rotating, the driving gear 136 can drive the transmission gear 132 to rotate about the transmission axis. The specific operation will be described in detail below. The transmission gear 132 is connected to the flap rotating shaft (not shown), such that the flap rotating shaft is driven to rotate when the transmission gear 132 rotates, so as to open and close the flap 190.

The plurality of transmission teeth 511, the abutting tooth 513, and the transmission gear abutting portion 512 are disposed on an outer periphery of the transmission gear 132. The plurality of transmission teeth 511 and the transmission gear abutting portion 512 are disposed on two opposite sides of the abutting tooth 513. The plurality of transmission teeth 511 and the abutting tooth 513 can engage with the plurality of driving teeth 502 of the driving gear 136, such that the driving gear 136 can drive the transmission gear 132 to rotate. The abutting tooth 513 and the plurality of transmission teeth 511 have the same shape, except that the abutting tooth 513 is provided over a part of the axial extent and close to the front side. In other words, the tooth thickness (axial dimension) of the abutting tooth 513 is less than the tooth thickness of the plurality of transmission teeth 511.

The transmission gear abutting portion 512 is provided over a part of the axial extent and extends for a distance in the circumferential direction. The transmission gear abutting portion 512 is disposed close to the rear side and thus is axially offset from the abutting tooth 513. Thus, a first tooth accommodating portion 515 is formed between the transmission gear abutting portion 512 and the adjacent transmission tooth 511, and is configured to accommodate the first driving tooth 501 of the plurality of driving teeth 502. The transmission gear abutting portion 512 has the transmission gear limiting surface 514. The transmission gear limiting surface 514 is an arc-shaped surface. The transmission gear limiting surface 514 can cooperate with a driving gear limiting surface 510. A distance between the transmission gear limiting surface 514 and the transmission axis, a distance between the tooth top of the plurality of transmission teeth 511 and the transmission axis, and a distance between the tooth top of the abutting tooth 513 and the transmission axis are equal.

The process of closing and locking the flap 190 will be described below with reference to FIGS. 10A-10C.

FIG. 10A is a schematic diagram showing the state of the flap assembly 100 when the flap 190 is completely opened; FIG. 10B is a schematic diagram showing the state of the flap assembly 100 when the locking device 120 is in the released position and the flap 190 is in the closed position; and FIG. 10C is a schematic diagram showing the state of the flap assembly 100 when the locking device 120 is in the locked position and the flap 190 is in the closed position. For the case of illustration of the positional relationship of the components in different states in FIGS. 10A-10C, the power source 150 and a front housing of the actuation device 130 are removed from FIGS. 10A-10C to better show the cooperative relationship of the components in the flap assembly 100. Rectangular dashed boxes at the bottoms of FIGS. 10A-10C are enlarged sectional views showing the cooperative relationship between the locking pin 128 of the locking device 120 and the flap hole 111 of the flap 190. Rectangular dashed boxes on the top left sides of FIGS. 10A-10C are enlarged views, viewed from front to back, showing the cooperative relationship between the driving member 135 and the transmission rod assembly 133. Rectangular dotted boxes on the top right sides of FIGS. 10A-10C are enlarged views, viewed from back to front, showing the cooperative relationship between the driving gear 136 and the transmission gear 132.

As shown in FIG. 10A, the flap 190 is in the open position. In this state, the locking device 120 is in the released position, and the locking pin 128 of the locking device 120 is inserted into the through hole 222 of the base 101, but is not inserted into the flap hole 111 of the flap 190; the transmission teeth 511 of the transmission gear 132 engage with the driving teeth 502 of the driving gear 136; and the driving portion 148 of the driving member 135 is disengaged from the transmission rod assembly 133, and the outer periphery of the disk portion of the driving member 135 abuts against the transmission rod assembly 133, such that the transmission rod assembly 133 is in a pushed-out position, and thus the locking device 120 is in the released position, and the clastic component 140 is compressed to provide a rightward elastic force. Moreover, in the state shown in FIG. 10A, since the flap 190 is in the open position, the locking end 192 of the flap 190 is the farthest away from the Hall sensor 181 on the base 101, and thus the Hall sensor 181 detects no or only a very small intensity of the magnetic field.

The process from FIG. 10A to FIG. 10B shows the process of the flap 190 from the open position to the closed position. In this process, the controller 110 controls the power source 150 to rotate by the first power source stroke in the first direction, such that the rotation of the power source 150 drives the driving shaft 134 to rotate in a clockwise direction. As a result, the driving member 135 rotates in the clockwise direction (i.e., in a clockwise direction in the upper left rectangular box of FIG. 10B), and the driving gear 136 also rotates by a first driving gear stroke in the clockwise direction (i.e., in a counterclockwise direction in the upper right rectangular box of FIG. 10B). As shown in FIG. 10A, when the driving gear 136 rotates in the clockwise direction, the driving teeth 502 of the driving gear 136 engage with the transmission teeth 511, such that the clockwise rotation of the driving gear 136 by the first driving gear stroke can drive the transmission gear 132 to rotate by a predetermined stroke in a counterclockwise direction (i.e., in a clockwise direction in the upper right rectangular box of the figure), and the rotation of the transmission gear 132 drives the flap 190 to rotate in the counterclockwise direction, so as to rotate the flap 190 to the closed position as shown in FIG. 10B. At this moment, the first driving tooth 501 of the driving gear 136 starts to disengage from the abutting tooth 513 of the transmission gear 132, and the transmission gear abutting portion 512 is accommodated in the accommodating portion 508. In the process from FIG. 10A to FIG. 10B, as the flap 190 moves toward the closed position, the magnet 182 on the flap 190 gradually approaches the Hall sensor 181, such that the intensity of the magnetic field detected by the Hall sensor 181 gradually increases.

It should be noted that there is an engaged state in the process from FIG. 10A to FIG. 10B. In this state, the driving portion 148 of the driving member 135 remains disengaged from the transmission rod assembly 133, while the outer periphery of the disk portion of the driving member 135 remains abutting against the transmission rod assembly 133. Therefore, in the engaged state, the transmission rod assembly 133 is always in the pushed-out position, which makes the locking device 120 always in the released position, and the elastic component 140 always in a state of being compressed to provide a rightward elastic force. The engaged state lasts until FIG. 10B.

In the state shown in FIG. 10B, the driving portion 148 of the driving member 135 engages with the transmission rod assembly 133. When the driving portion 148 of the driving member 135 engages with the transmission rod assembly 133, the protrusion 147 of the driving member 135 moves to a lower end of the guiding groove 259 of the transmission rod assembly 133, and the driving portion 148 of the driving member 135 moves to and abuts against a lower portion of the engagement surface 258 of the transmission rod assembly 133. At this moment, the transmission rod assembly 133 still remains in the pushed-out position. Therefore, the locking device 120 is still in the released position, and the clastic component 140 is still in the state of being compressed to provide the rightward elastic force.

When the position shown in FIG. 10B is reached, the controller 110 controls the power source 150 to pause driving of the driving device. Therefore, the driving device 131 (the driving shaft 134, the driving member 135, and the driving gear 136) stops rotating, and the transmission rod assembly 133 and the transmission gear 132 driven by the driving device 131 also stop moving. Further, when the position shown in FIG. 10B is reached, since the flap locking end 192 reaches the closed position, the intensity of the magnetic field detected by the Hall sensor 181 is equal to or greater than the predetermined maximum threshold, and the Hall sensor 181 then sends to the controller 110 the first signal indicating that the flap locking end 192 reaches the locking-end closed position. Therefore, the controller 110 controls the power source 150 to continue rotating by the second power source stroke in the first direction so as to perform an operation of locking the flap 190. This process is shown in FIGS. 10B to 10C and will be described in detail below. If when the position shown in FIG. 10B is reached, the Hall sensor sends to the controller 110 the second signal indicating that the flap locking end 192 does not reach the locking-end closed position, the controller 110 thus controls the power source 150 to rotate reversely (i.e., in the second direction opposite the first direction). The power source 150 rotates reversely to drive the driving shaft 134 to rotate in the counterclockwise direction, such that the driving member 135 rotates in the counterclockwise direction (i.e., in a counterclockwise direction in the upper left rectangular box of FIG. 10B), and the driving gear 136 also rotates in the counterclockwise direction (i.e., in the clockwise direction in the upper right rectangular box of FIG. 10B). The rotation of the driving gear 136 in the counterclockwise direction drives the transmission gear 132 to rotate in the clockwise direction (i.e., in the counterclockwise direction in the upper right rectangular box of FIG. 10B), such that the flap 190 moves toward the open position and the locking end 192 of the flap 190 moves toward the locking-end open position. In some aspects, the flap 190 rotates back to the open position shown in FIG. 10A, and the locking end 192 of the flap 190 returns to the locking-end open position shown in FIG. 10A. After removing the abnormal circumstance, the operator sends the instruction to close the flap 190 again to the controller 110. The controller 110 re-controls, based on the instruction, the power source 150 to rotate to close the flap 190 (i.e., performing the process shown in FIG. 10A to FIG. 10B).

Next, the process of locking the flap 190 shown in FIGS. 10B to 10C is described. In the process shown in FIGS. 10B to 10C, the controller 110 controls the power source 150 to continue rotating by the second power source stroke in the same direction (i.e., the first direction) as from FIGS. 10A and 10B, such that the driving device 131 (the rotating shaft 134, the driving member 136 and the driving gear 136) continue rotating in the same direction as in FIGS. 10A and 10B. That is, the power source 150 drives the rotating shaft 134 to continue rotating in the clockwise direction, such that the driving member 135 continues rotating in the clockwise direction (i.e., in the clockwise direction in the upper left rectangular box of FIG. 10B), and the driving gear 136 also continues rotating by the second driving gear stroke in the clockwise direction (i.e., in the counterclockwise direction in the upper right rectangular box of FIG. 10B). In this process, on the one hand, the plurality of driving teeth 502 of the driving gear 136 are disengaged from the plurality of transmission teeth 511 of the transmission gear 132, such that the rotation of the driving gear 136 no longer drives the transmission gear 132 to rotate, but the driving gear 136 rotates relative to the transmission gear 132. More specifically, the driving gear 136 continues rotating in the clockwise direction (i.e., in the counterclockwise direction in the upper right rectangular box of FIG. 10B) until the driving gear 136 reaches the position shown in FIG. 10C. That is, once the driving gear limiting surface 510 of the driving gear limiting tooth 506 of the driving gear 136 abuts against the transmission gear limiting surface 514 of the transmission gear 132, the driving gear 136 no longer continues rotating in the clockwise direction (i.e., in the counterclockwise direction in the upper right rectangular box of FIG. 10C). Further, when the driving gear 136 reaches the position shown in FIG. 10C, the top portion 505 of the driving gear abutting portion 504 of the driving gear 136 abuts against the abutting tooth 513 of the transmission gear 132 to block the rotation of the transmission gear 132 in the clockwise direction (i.e., in the counterclockwise direction in the upper right rectangular box of FIG. 10C). Therefore, the flap 190 remains in the closed position. On the other hand, the notch of the driving member 135 provides an accommodating space for the engagement surface 258 of the transmission rod assembly 133, thereby providing a space for the rightward movement of the transmission rod assembly 133. In the state shown in FIG. 10B, the protrusion 147 of the driving member 135 has reached the lower end of the guiding groove 259 of the transmission rod assembly 133, and the driving portion 148 of the driving member 135 has abutted against the lower portion of the engagement surface 258 of the transmission rod assembly 133. That is to say, in the state shown in FIG. 10B, the engagement surface 258 of the transmission rod assembly 133 is ready to enter the notch of the driving member 135. Therefore, during the movement from the state shown in FIG. 10B to the state shown in FIG. 10C, as the driving member 135 continues rotating in the clockwise direction (i.e., in the clockwise direction in the upper left rectangular box of FIG. 10B), the locking device 120 and the transmission rod assembly 133 can move to the right under the action of the rightward force provided by the clastic component 140. Specifically, as the driving member 135 rotates in the clockwise direction, the protrusion 147 of the driving member 135 slides against a right wall of the guiding groove 259 of the transmission rod assembly 133 to reach an upper end of the guiding groove 259, and the driving portion 148 of the driving member 135 slides against the engagement surface 258 of the transmission rod assembly 133, such that the engagement surface 258 of the transmission rod assembly 133 enters the notch of the transmission member 135. Accordingly, the transmission rod assembly 133 and the locking device 120 can move to the right under the action of the elastic component 140. When the engagement surface 258 of the transmission rod assembly 133 fully enters the notch of the transmission member 135, the transmission rod assembly 133 returns to a retracted position and no longer exerts a leftward force to the locking device 120, the compressed elastic component 140 thus rebounds to the right to an initial state, the locking device 120 reaches the locked position, and the locking pin 128 is inserted into the flap hole 111 to lock the flap 190 in the closed position.

As described above, in the state shown in FIG. 10C, the abutting tooth 513 of the transmission gear 132 abuts against the top portion 505 of the driving gear abutting portion 504 of the driving gear 136 to block the rotation of the transmission gear 132 in the clockwise direction (in the counterclockwise direction in the upper right rectangular box of FIG. 10C). This requires to first drive the driving gear 136 to rotate in the counterclockwise direction (in the clockwise direction in the upper right rectangular box of FIG. 10C), such that the transmission gear 132 is driven by the driving gear 136 to rotate in the clockwise direction (in the counterclockwise direction in the upper right rectangular box of FIG. 10C). Therefore, in the state shown in FIG. 10C, it is necessary to rotate the power source 150 reversely in the second direction to rotate the driving gear 136 in the counterclockwise direction (in the clockwise rotation in the upper right rectangular box of FIG. 10C), such that the driving gear 136 drives the transmission gear 132 to rotate in the clockwise direction (in the counterclockwise direction in the upper right rectangular box of FIG. 10C), thereby rotating the flap 190 toward the open position. If the power source 150 does not rotate reversely, the driving gear 136 remains stationary, and the rotation of the transmission gear 132 in the clockwise direction (in the counterclockwise direction in the upper right rectangular box of FIG. 10C) is limited, and thus the rotation of the flap 190 toward the open position is limited. That is to say, after the driving member 135 and the driving gear 136 reach the position shown in FIG. 10C, it is necessary to rotate the power source 150 reversely to perform the operation of opening the flap 190 (i.e., the process from FIG. 10C to FIG. 10A).

It should be understood that in the case of the flap 190 having a low rigidity, if the flap locking end 192 is tilted up due to foreign matter stuck between the flap locking end 192 and the base 101, etc. and thus fails to reach the locking-end closed position, the low rigidity of the flap 190 allows the connecting end 191 to still reach the connecting-end closed position, and thus the driving member 135 and the driving gear 136 can still reach the position shown in FIG. 10B. As a result, even if the flap locking end 192 does not reach the locking-end closed position, it is possible to continue driving the driving member 135 and the driving gear 136 to rotate from the position shown in FIG. 10B to the position shown in FIG. 10C, such that the driving device 120 is driven to the locked position. In this case, since the flap locking end 192 does not reach the locking-end closed position, the flap hole 111 cannot be aligned with the locking pin 128, and when the driving device 120 is driven to the locked position, the locking pin 128 cannot be inserted into the flap hole 111 to lock the flap 190. That is, in the case of the flap 190 having the low rigidity, the situation, in which the locking device 120 reaches the locked position, the driving member 135 and the driving gear 136 reach the position shown in FIG. 10C, and the connecting end 191 reaches the connecting-end closed position, but the locking end 192 is tilted up and does not reach the locking-end closed position, may occur. Since the flap locking end 192 is tilted up in this case, the operator is prone to try to manually open the flap 190 or press down the flap locking end 192 to make the flap locking end 192 reach the locking-end closed position. However, as mentioned above, when the driving member 135 and the driving gear 136 reach the position shown in FIG. 10C, the abutting tooth 513 of the transmission gear 132 abuts against the top portion 505 of the driving gear abutting portion 504 of the driving gear 136. Unless the driving gear 136 is driven to rotate in the counterclockwise direction (in the clockwise rotation in the upper right rectangular box of FIG. 10C) so as to drive the transmission gear 132 to rotate in the clockwise direction (in the counterclockwise direction in the upper right rectangular box of FIG. 10C), the driving gear 136 limits the rotation of the transmission gear 132 in the clockwise direction (in the counterclockwise direction in the upper right rectangular box of FIG. 10C). This results that the flap 190 cannot be manually opened. Alternatively, if the operator applies a large force to force the flap 190 to be opened manually, the transmission gear 132 will be forced to rotate in the clockwise direction (in the counterclockwise direction in the upper right rectangular box of FIG. 10C), which will cause damage to the transmission gear 132 and/or the driving gear 136. Furthermore, since the driving device 120 has been driven to the locked position in this case, the locking pin 128 has protruded to the right, and the locking pin 128 thus blocks the operator's operation of pressing down the flap locking end 192, such that it is impossible for the flap locking end 192 to reach the locking-end closed position by pressing down the locking end manually, or the operator's manual operation of pressing down the flap locking end 192 causes damage to the flap 190 and/or the locking pin 128.

In the system and method according to the present application, after the driving member 135 and the driving gear 136 reach the position shown in FIG. 10B, an operation of checking whether the flap locking end 192 reaches the locking-end closed position is performed. According to the present application, it is ensured that the flap locking end 192 reaches the locking-end closed position before continuing driving the driving member 135 and the driving gear 136 to rotate to the position shown in FIG. 10C to drive the locking device 120 to the locked position to lock the flap 190. Therefore, according to the system and method of the present application, it can be ensured that the flap locking end 192 reaches the locking-end closed position before performing the operation of locking the flap 190, thereby preventing the flap locking end 192 from failing to reach the locking-end closed position due to foreign matter, etc. and thus not being locked in the closed position, and avoiding the inability to manually open the flap 190 or to manually press down the flap locking end 192 to the locking-end closed position, or avoiding damage to the flap 190, the driving gear 136, the transmission gear 132 and/or the locking pin 128 caused by manually opening the flap 190 or manually pressing down the flap locking end 192 to the locking-end closed position.

It should be understood that the process from FIG. 10C to FIG. 10B is a process of releasing the flap 190, and the process from FIG. 10B to FIG. 10A is a process of rotating the flap 190 from the closed position to the open position. As long as the power source 150 is rotated reversely to drive the driving shaft 134 to rotate in the counterclockwise direction, and thus drive the driving member 135 to rotate in the counterclockwise direction (i.e., in the counterclockwise direction as shown in the upper left rectangular box of FIG. 10C) and drive the rotating gear 136 to rotate in the counterclockwise direction (i.e., in the clockwise direction in the upper right rectangular box of FIG. 10C), the process from FIG. 10C to FIG. 10A can be implemented to release and open the flap 190. Unlike the process of closing and locking the flap 190, in the process of releasing and opening the flap 190, the controller 110 controls the power source 150 to continuously rotate to release and open the flap 190 without interruption, until the flap 190 is opened completely.

It should also be understood that the method for closing and locking a flap according to the present application is applicable to flap assemblies having various structures. The specific structure of the flap assembly 100 according to the method and system of the present application described above is merely an example, and should not be construed as limiting specific applications of the method and system of the present application. Specifically, in another aspect of a flap assembly to which the method and system of the present application are applicable, the flap assembly is configured with a driving device 131 having a different structure for transmitting the driving power of the power source 150; a flap driving mechanism 132 having a different structure for driving the flap 190 to rotate between the open position and the closed position; and/or a locking driving mechanism 133 having a different structure for driving the locking devices 120 to move linearly. More specifically, unlike the aspect of the present application in which the locking driving mechanism 133 is configured to perform the linear movement that drives the locking device 120 to move linearly, in some aspects, the locking driving mechanism is configured to perform a rotary movement that drives the locking device 120 to move linearly.

FIG. 11 is a schematic block diagram of the controller 110. FIG. 11 shows main components of the controller 110. The controller 110 can store and execute programs involved in the processes shown in FIGS. 10A-10C.

As shown in FIG. 11, the controller 110 comprises a bus 1101, a processor 1102, a memory 1103, an input interface 1104, and an output interface 1105. The processor 1102, the memory 1103, the input interface 114 and the output interface 1105 are connected to the bus 1101. The processor 1102 can read programs (or instructions) from the memory 1103 and execute the programs (or instructions); and the processor 1102 may also write the programs (or instructions) into the memory 1103. The memory 1103 may store the programs (instructions). By executing the instructions in the memory 1103, the processor 1102 may control the memory 1103, the input interface 1104, and the output interface 1105. In the present application, the memory 1103 can store the programs for executing the processes shown in FIGS. 10A-10C.

The input interface 1104 is configured to receive instructions from the outside (e.g. a user) and feedback signals from the position detector 180. The output interface 1105 is configured to receive a control signal from the processor 1102 and transmit the control signal to the power source 150 to control the rotation thereof. In addition, in some aspects, the output interface transmits the control signal to the position detector 180 to control the position detector to detect whether the flap locking end 192 reaches the locking-end closed position.

The present application provides a number of technical effects. First, the situation, in which only the flap connecting end 191 reaches the connecting-end closed position, while the flap locking end 192 does not reach the locking-end closed position to cause the flap 190 to fail to close the accommodating cavity 105, is avoided. Second, damage to components, caused the operator manually opening the flap 190 or manually pressing down the flap locking end 192 when finding that the flap locking end 192 is tilted up, is avoided.

Although the present application is described with reference to the examples of aspects outlined above, various alternatives, modifications, variations, improvements and/or substantial equivalents, which are known or anticipated at present or to be anticipated before long, may be obvious to those of at least ordinary skill in the art. Furthermore, the technical effects and/or technical problems described in this description are exemplary rather than limiting. Therefore, the disclosure in this description may be used to solve other technical problems and have other technical effects and/or may solve other technical problems. Accordingly, the examples of the aspects of the present application as set forth above are intended to be illustrative rather than limiting. Various changes may be made without departing from the spirit or scope of the present application. Therefore, the present application is intended to embrace all known or earlier disclosed alternatives, modifications, variations, improvements and/or substantial equivalents.

What is claimed is:

1. A method for closing and locking a flap, the method comprising:
(S1) driving a flap driving mechanism (132) to move by a predetermined stroke, the predetermined stroke enabling a locking end (192) of the flap (190) to reach a locking-end closed position;
(S2) detecting that the locking end (192) of the flap (190) does not reach the locking-end closed position; and
(S3) driving the flap driving mechanism (132) to move reversely, so as to drive the flap (190) to move back toward an open position.

2. The method for closing and locking a flap according to claim 1, wherein driving the flap (190) to move back to the open position in the step (S3).

3. The method for closing and locking a flap according to claim 1, wherein performing the step (S2) after the flap driving mechanism (132) finishes the predetermined stroke.

4. The method for closing and locking a flap according to claim 1, wherein performing the step (S3) in response to detecting that the locking end (192) does not reach the locking-end closed position.

5. The method for closing and locking a flap according to claim 1, wherein detecting by means of a Hall sensor (181) that the locking end (192) of the flap (190) does not reach the locking-end closed position in the step (S2).

6. The method for closing and locking a flap according to claim 1, wherein detecting by means of a position switch (183) that the locking end (192) of the flap (190) does not reach the locking-end closed position in the step (S2).

7. The method for closing and locking a flap according to claim 1, character by comprising:
performing step (S2-1) in the step (S2), the step (S2-1) turning the operation to the step (S3) in response to detecting that the locking end (192) does not reach the locking-end closed position.

8. The method for closing and locking a flap according to claim 7, further comprising:
(S4) driving a locking device (120) to lock the flap (190) in a closed position;
wherein the step (S2) comprises performing step (S2-2), which turns the operation to the step (S4) in response to detecting that the locking end (192) reaches the locking-end closed position.

9. The method for closing and locking a flap according to claim 1, further comprising:
(S0) receiving an instruction to close the flap (190), prior to the step (S1).

10. The method for closing and locking a flap according to claim 9, further comprising:
returning to the step (S0) following removing an abnormal circumstance, after the step (S3).

11. The method for closing and locking a flap according to claim 8, wherein
in the step (S1), a driving source is a single power source (150), the single power source (150) being driven to rotate by a first stroke in a first direction, so as to drive the flap driving mechanism (132) to move by the predetermined stroke;
in the step (S3), the single power source (150) is driven to rotate in a second direction opposite the first direction to drive the flap driving mechanism (132) to move reversely, so as to drive the flap (190) to move back toward the open position; and
in the step (S4), the single power source (150) is driven to continue rotating in the first direction by a second stroke, so as to drive the locking device (120) to lock the flap (190) in the closed position.

12. The method for closing and locking a flap according to claim 1, wherein the flap (190) is used for a vehicle refueling or charging port.

13. A flap system comprising:
a flap (190), the flap (190) comprising a locking end (192) having a locking-end open position and a locking-end closed position, and the flap (190) being configured to be able to move from a flap open position to a flap closed position;
a position detector (180), the position detector (180) being configured to detect a position of the locking end (192); and
a controller (110), the controller (110) being configured to control movement of the flap (190) from the flap open position to the flap closed position, wherein the controller (110) controls the locking end (192) to move toward the locking-end open position when the position detector (180) detects that the locking end (192) does not reach the locking-end closed position.

14. The flap system according to claim 13, wherein the position detector (180) is a Hall sensor (181).

15. The flap system according to claim 13, wherein the position detector (180) is a position switch (183).

16. The flap system according to claim 13, further comprising:
a flap driving mechanism (132), the flap driving mechanism (132) being connected to the flap (190), and the flap driving mechanism (132) being configured to be movable by a predetermined stroke, so as to drive the flap (190) to move from the flap open position to the flap closed position;
a locking device (120), the locking device (120) being movable between a locked position in which the locking device (120) locks the flap (190) at the locking end (192) and a released position in which the locking device (120) releases the flap (190); and
a locking driving mechanism (133), the locking driving mechanism (133) being configured to drive the locking device (120) to move between the locked position and the released position,
wherein after the flap driving mechanism (132) moves by the predetermined stroke, if a detection result of the position detector (180) indicates that the locking end (192) does not reach the locking-end closed position, the controller (110) controls to drive the flap driving mechanism (132) to move reversely, so as to drive the flap (190) to move toward the open position; or
wherein after the flap driving mechanism (132) moves by the predetermined stroke, if a detection result of the position detector (180) indicates that the locking end (192) reaches the locking-end closed position, the controller (110) controls to drive the locking driving mechanism (133) to move the locking device (120) to the locked position, so as to lock the flap (190) in the closed position.

17. The flap system according to claim 16, further comprising:
a single power source (150) for driving the flap driving mechanism (132) and the locking driving mechanism (133);
wherein the controller (110) is configured to control the single power source (150) to rotate by a first stroke in a first direction to drive the flap driving mechanism (132) to move by the predetermined stroke, so as to close the flap (190);
wherein the controller (110) is configured to control the single power source (150) to rotate in a second direction opposite the first direction to drive the flap driving mechanism (132) to move reversely, so as to open the flap (190); and
wherein the controller (110) is configured to control the single power source (150) to continue rotating in the first direction by a second stroke to drive the locking driving mechanism (133), such that the locking device (120) locks the flap (190) in the closed position.

18. The flap system according to claim 17, wherein the flap system (10) is used for a vehicle refueling or charging port.

19. A vehicle comprising a flap system (10) according to claim 13.
